(19) United States
(12) Patent Application Publication
(10) Pub. No.: US 2010/0291434 A1
(43) Pub. Date: Nov. 18, 2010

(54) CONNECTOR AND BATTERY PACK HAVING THE SAME

(75) Inventors: Bohyun Byun, Suwon-si (KR); Jongpil Kim, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/778,244

(22) Filed: May 12, 2010

(30) Foreign Application Priority Data
May 14, 2009 (KR) 10-2009-0042083

(51) Int. Cl. H01M 2/30; H01R 13/40

(52) U.S. Cl. 429/178; 439/597

(57) ABSTRACT

A connector electrically connecting a battery pack to an electronic device and a battery pack having the same, the connector including a connector body and contacts formed with the connector body and into which an external terminal is inserted to be electrically connected thereto, and supports formed between the connector body and the contacts to prevent the contacts and the connector body from deformation caused by insertion of a terminal of an electronic device.

### CROSS-REFERENCE TO RELATED APPLICATION

This application claims the benefit of Korean Patent Application No. 10-2009-0042083, filed on May 14, 2009 in the Korean Intellectual Property Office, the disclosure of which is incorporated herein in its entirety by reference.

### BACKGROUND OF THE INVENTION

1. Field of the Invention

Aspects of the present invention relate to a connector of a battery pack electrically connecting the battery pack to an electronic device, and a battery pack having the same.

2. Description of the Related Art

In recent years, compact and lightweight portable electric and electronic devices (such as cellular phones, laptop computers, and camcorders) have been actively developed and manufactured. These portable electric and electronic devices have a battery pack to power the portable electric and electronic devices at an external site without a separate external power source. A rechargeable secondary battery (such as a Nickel-Cadmium (Ni—Cd) battery, a Nickel-Metal Hydrogen (Ni-MH) battery, a Lithium (Li) battery, or a Lithium ion (Li-ion) battery) is employed in the battery pack according to economical interests. An operating voltage of a lithium ion secondary battery is three times higher than that of a Ni—Cd battery or a Ni-MH battery used as a power source of the portable electronic device. Furthermore, since an energy density per unit weight of a lithium ion secondary battery is higher than that of a Ni—Cd battery or a Ni-MH battery, a lithium ion secondary battery is widely used.

The secondary battery includes a lithium oxide as a positive electrode active material and a carbon material as a negative electrode active material. Generally, the secondary battery is classified as a liquid electrolyte battery or a polymer electrolyte battery according to the kind of the electrolyte used. Moreover, a secondary battery using the liquid electrolyte is referred to as a lithium ion battery and a secondary battery using the polymer electrolyte is referred to as a lithium polymer battery.

The secondary battery is manufactured by an electrical connection between a protection circuit module (PCM) and a bare cell in which an electrode assembly and an electrolyte are accommodated in a case (such as a can). The bare cell is charged and discharged by electrochemical reactions, and the PCM prevents the bare cell from overcharging and over-discharging to protect the bare cell. An assembly of the bare cell and the PCM is referred to as a core-pack. A connector is mounted on the PCM of the core-pack. The connector includes connector terminals corresponding to each other. The connector serves as a medium to transmit electric current generated from the bare cell to an outside during the discharge and vice versa during the charge. Connector terminals of an electronic device are inserted between the connector terminals of the secondary battery so that the electronic device is electrically connected to the secondary battery.

However, when the battery pack is repeatedly mounted to and separated from the existing electric device and the existing electronic device, the distance between the connector terminals increases. When the distance between the connector terminals excessively increases due to an external shock, the electrical connection between the battery pack and the electronic device deteriorates. As such, the widened distance between the connector terminals of the connector causes inferior electrical connection so that electric power is not properly supplied from the battery pack to the electronic device.

### SUMMARY OF THE INVENTION

Aspects of the present invention provide a connector having connector terminals that are prevented from being deformed by repeated use of the connector. Aspects of the present invention also provide a connector having connector terminals that are prevented from being deformed by an external shock.

According to an aspect of the present invention, there is provided a connector including: a connector body; a contact integrally formed with the connector body into which an external terminal is inserted to be electrically connected thereto; and a support formed on the connector body and the contact to prevent the contact from deforming.

The support may be coupled to the connector body to support the contact and may be coupled to something other than the connector body.

The support may have elasticity sufficient to prevent the connector body from moving.

The support may be made of a non-elastic material to prevent deformation of the contact.

The support may be made of a material having elasticity and hardness such as a reinforcing plastic fiber or an equivalent material.

The connector body may include two bending portions having U-shaped sections to face each other.

The support may be formed between the connector body and the bending portions, respectively.

According to another aspect of the present invention, there is provided a battery pack including: a bare cell; a protective circuit module electrically connected to the bare cell to control charge and discharge of the bare cell; a cover frame to protect the protective circuit module; and a connector mounted on the protective circuit module to serve as a current transmission path from the bare cell to the outside of the bare cell, the connector including: a connector body, a contact integrally formed with the connector body into which an external terminal is inserted to be electrically connected thereto, a substrate mounting integrally formed with the connector body to be electrically connected to the protective circuit board, and a support formed on the connector body.

The protective circuit module may have a terminal hole formed on a substrate body of the protective circuit module to transmit an electric current from the bare cell to an outside such that a substrate mounting of the connector is mounted to the protective circuit module.

The cover frame may include a terminal slot to expose the contact of the connector.

The support may be coupled to the connector body to support the contact.

The connector body may include two bending portions having a U-shaped section to face each other.

The support may be formed between the connector body and a bending portion.

The connector may further include a substrate mounting integrally formed with the connector body to be electrically connected to the protective circuit board.

According to another aspect of the present invention, there is provided a connector to electrically connect a bare cell of a battery to an external terminal and to provide a current path therebetween, the connector including: a connector body into which the external terminal is inserted; first and second contacts integrally provided on the connector body to electrically connect the inserted external terminal thereto; and first and second supports formed on the connector body to prevent the connector body from deforming when the external terminal is inserted, wherein the external terminal is inserted between the first and second contacts, the first support is formed on the connector body to a side of the first contact opposite from the second contact, and the second support is formed on the connector body to a side of the second contact opposite from the first contact.

Since the battery pack used as a power source of an electronic device discharges and charges, a charged battery pack is attached to and detached from the electronic device, repeatedly. Thus, according to aspects of the present invention, inferior connection between the electronic device and the battery pack due to a widened space between the connector terminals caused by an external shock applied to the battery pack before and after the attachment of the battery pack to an electronic device may be prevented.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a battery pack according to an embodiment of the present invention;

FIG. 2 is a front view illustrating a connector according to an embodiment of the present invention;

FIG. 3 is a front view illustrating connectors mounted on a substrate according to the embodiment of the present invention; and

FIG. 4 is a front view illustrating a cover frame coupled to a connector according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

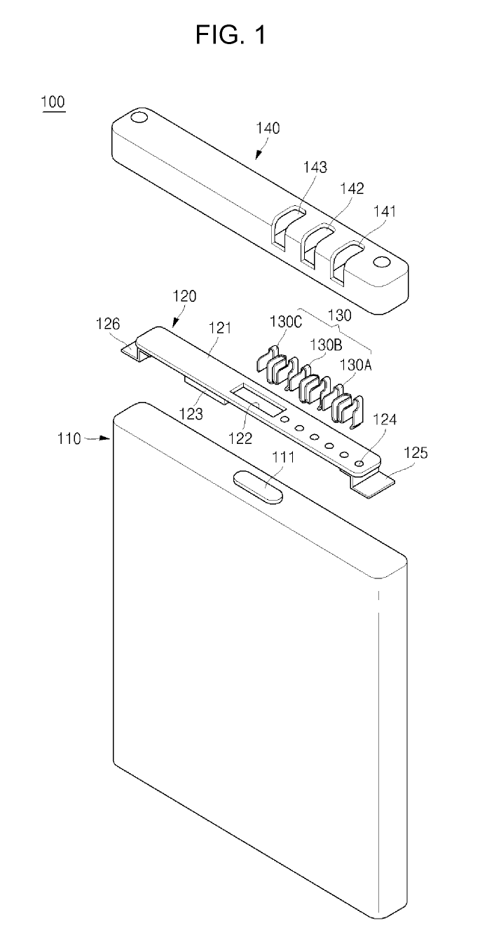

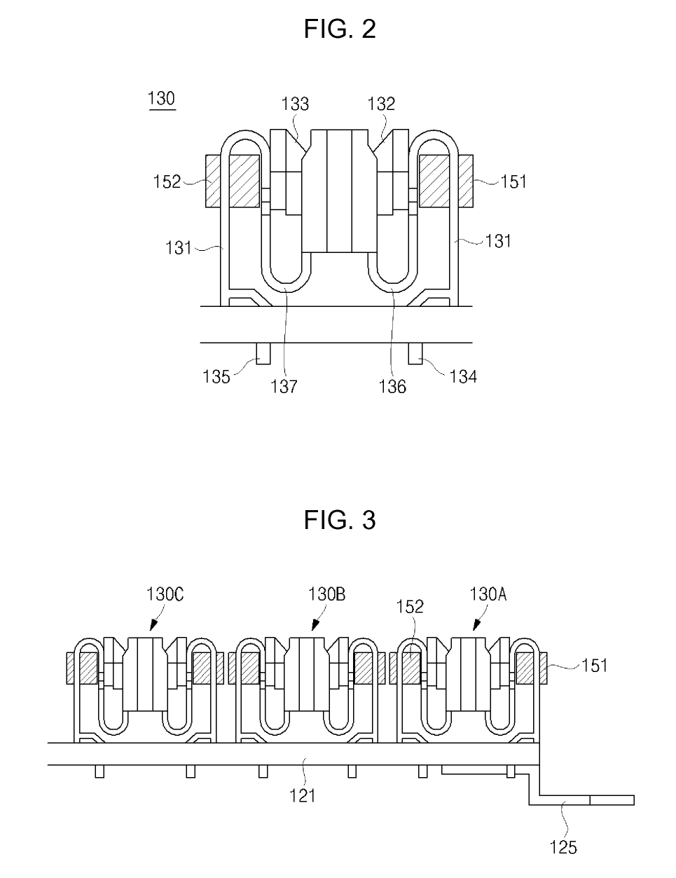

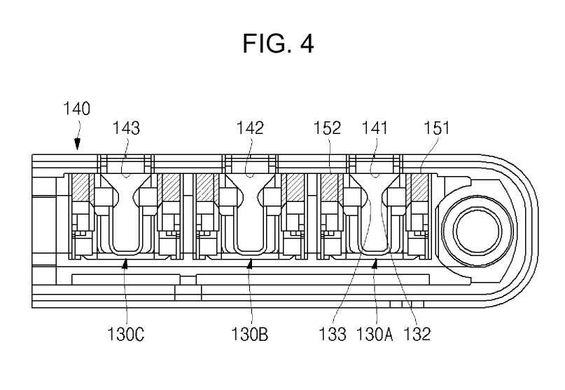

FIG. 1 is an exploded perspective view illustrating a battery pack 100 according to an embodiment of the present invention, FIG. 2 is a front view illustrating a connector 130 according to an embodiment of the present invention, FIG. 3 is a front view illustrating the connector 130 mounted on a substrate, and FIG. 4 is a front view illustrating a cover frame 140 coupled to a connector 130 according to another embodiment of the present invention.

Referring to the FIGS. 1 to 4, a battery pack 100 according to an embodiment of the present invention includes a bare cell 110 to generate an electric current, a protective circuit module (PCM) 120 electrically connected to the bare cell 110 to control a charge-discharge of the bare cell 110, a cover frame 140 to protect the PCM 120, and a connector 130 serving as a current path between the bare cell 110 and an external device. The connector 130 includes three connectors 130A, 130B, and 130 C that are mounted on the PCM 120.

The bare cell 110 includes an electrode assembly (not shown) that is formed by winding a positive electrode plate, a negative electrode plate, and a separator interposed therebetween. The bare cell 110 further includes a can or a case member accommodating the electrode assembly and an electrolyte (not shown). While other embodiments are not limited thereto, in the shown embodiment, the bare cell 110 has a rectangular parallelepiped shape so that the bare cell 110 has wide lateral sides, narrow lateral sides extended from the wide lateral sides, and top and bottom sides formed on the top and bottom sides of the wide and narrow lateral sides. An electrode terminal 111 protrudes over the PCM 120 side of the bare cell 110. The electrode terminal 111 is a positive electrode or a negative electrode. As an example, when the electrode terminal 111 is a negative electrode, the external surface of the bare cell 110 becomes a positive electrode.

The PCM 120 includes a plate-shaped substrate body 121. The substrate body 121 has a through-hole 122 for an electric connection of the electrode terminal 111 formed in the center thereof. Parts 123 of the PCM 120 are mounted on the lower side of the substrate body 121 to protect the bare cell 110 from overcharging and overdischarging. A plurality of terminal holes 124 is provided on the substrate body 121 to transmit electric current from the bare cell to the outside. The connector 130 is mounted in the terminal holes 124.

The PCM 120 includes first and second lead plates 125 and 126 that are electrically connected to the positive and negative electrodes of the bare cell 110. In this case, the exterior surface of the bare cell 110 becomes the positive electrode and the protruded electrode terminal 111 becomes the negative electrode, though aspects of the present invention are not limited thereto.

The connector 130 includes three connectors 130A, 130B, and 130C. The three connectors 130A, 130B, and 130C serve as a positive electrode terminal, a negative electrode terminal, and a connector terminal to transmit information on a battery. The three connectors 130A, 130B, and 130C have the same structure. Thus, the structure of the connector 130 will be described by taking one of the connectors 130A, 130B, or 130C as an example.

The connector 130 includes a connector body 131, first and second contacts 132 and 133, and first and second substrate mountings 134 and 135. The connector body 131 includes two bending portions 136 and 137 having a U-shaped section to face each other. The first and second contacts 132 and 133 are respectively provided on both ends of the bending portions 136 and 137 facing each other. The first and second contacts 132 and 133 protrude in the directions where the first and second contacts face each other. Therefore, terminals of an electronic device are inserted between the first and second contacts 132 and 133 such that an electric connection is achieved. The substrate mountings 134 and 135 are integrally provided on the PCM 120 side of the connector body 131 in the vertical direction.

The connector 131 further includes first and second supports 151 and 152 provided between the connector body 131 and the two bending portions 136 and 137. The supports 151 and 152 support the elastic connector body 131 and bending portions 136 and 137 so as to not exceed the elastic imit. Moreover, the supports 151 and 152 may be made of a non-elastic material, such that the supports 151 and 152 support the connector body 131 and the bending portions 136 and 137 with a constant supporting force so that deformation and movement of the connector body 131 and the bending portions 136 and 137 may be prevented.

Furthermore, the supports 151 and 152 may have an elastic force sufficient to prevent the connector body 131 from moving. Namely, the bending portions 136 and 137 may be compressed during the insertion of terminals of an electronic device. Accordingly, when the connector is disconnected from terminals of the electronic device, the bending portions 136 and 137 may be restored to their initial state. The supports 151 and 152 may be made of a material having elasticity and hardness such as a reinforcing plastic fiber or an equivalent material.

As described above, the supports 151 and 152 may be made of any material that prevents a distance between the contacts from excessively widening due to the insertion of the external terminals between the connector body 131 and the bending portions 136 and 137, or an external shock.

The connector 130 may have any shape to prevent the connector body 131 and the bending portions 136 and 137 from being deformed. The connector 130 is illustrated in the drawings only as an example, but may have various forms and shapes.

The cover frame 140 is provided on the PCM 140 side of the bare cell 110 to surround the PCM 120. The cover frame 140 has terminal slots 141, 142, and 143 provided in a side thereof to expose the contacts 132 and 133 of the connectors 130A, 130B, and 130C. By doing so, the terminal slots 141, 142, and 143 are provided in the cover frame 140 to correspond to positions of the connectors 130A, 130B, and 130C.

Hereinafter, operations of the connector 130 according to the embodiment of the present invention and a battery pack 100 having the same will be described. The battery pack 100 may be assembled by sequentially assembling the PCM 120 to the bare cell 110, and then coupling the cover frame 140 to the bare cell 110.

The PCM 120 is mounted on the side of the bare cell 110 from which the electrode terminal 111 protrudes. The PCM 120 may be spot welded to the electrode terminal 111 such that a negative electrode is electrically connected thereto, and the lead plates 125 and 126 are laser welded thereto. At least one of the lead plates 125 and 126 is electrically connected to a positive electrode.

The connectors 130A, 130B, and 130C are mounted through the terminal holes 124 provided on the side of the PCM 120.

The cover frame 140 is coupled to the PCM 120, opposite the bare cell 110. The contacts 132 and 133 corresponding to the terminals of the connectors 130A, 130B, and 130C are exposed to the outside through the terminal slots 141, 142, and 143 of the cover frame 140.

The assembled battery pack is electrically connected to terminals of an electronic device. In other words, the terminals of an electronic device inserted into the terminal slots 141, 142, and 143 are positioned between the contacts 132 and 133 of the respective connectors 130A, 130B, and 13C to be electrically connected thereto. The supports 151 and 152 support the contacts 132 and 133 on both sides of the contacts 132 and 133 spreading bidirectionally by the electrode terminals of an electronic device. Therefore, the supports 151 and 152 prevent the connector body 131 and the bending portions 136 and 137 of the connectors 130A, 130B, and 130C from deforming even after the separation of the terminals of an electronic device from the connectors 130A, 130B, and 130C.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A connector to electrically connect a bare cell of a battery to an external terminal and to provide a current path therebetween, the connector comprising:
a connector body into which the external terminal is inserted;
a contact provided on the connector body to electrically connect the inserted external terminal thereto; and
a support formed on the connector body to prevent the connector body from deforming when the external terminal is inserted.

2. The connector as claimed in claim 1, wherein the support is coupled to the connector body to support the contact.

3. The connector as claimed in claim 1, wherein the support has an elasticity to prevent the connector body from moving when the external terminal is inserted.

4. The connector as claimed in claim 1, wherein the connector body includes first and second bending portions, each having a U-shaped section to face each other.

5. The connector as claimed in claim 4, further comprising another contact to electrically connect the inserted external terminal, wherein the contact is provided on an end of the first bending portion and the other contact is provided on an end of the second bending portion.

6. The connector as claimed in claim 4, further comprising another support formed on the connector body to prevent the connector body from deforming when the external terminal is inserted.

7. The connector as claimed in claim 6, wherein the support is formed on the connector body to a side of the first bending portion opposite from the contact, and the other support is formed on the connector body to a side of the second bending portion opposite from the contact.

8. The connector as claimed in claim 5, further comprising another support formed on the connector body to prevent the connector body from deforming when the external terminal is inserted.

9. The connector as claimed in claim 8, wherein the support is formed on the connector body to a side of the first bending portion opposite from the contact, and the other support is formed on the connector body to a side of the second bending portion opposite from the other contact.

10. The connector as claimed in claim 5, wherein the external terminal is inserted between the contact and the other contact.

11. The connector as claimed in claim 1, wherein the support is formed on the connector body and the contact to prevent the connector body and the contact from deforming when the external terminal is inserted

12. A battery pack comprising;
a bare cell to generate an electric current;
a protective circuit module electrically connected to the bare cell to control a charge and a discharge of the bare cell;
a cover frame to protect the protective circuit module; and
a connector mounted on the protective circuit module to provide a current transmission path from the bare cell to an external terminal outside of the bare cell, the connector comprising;
a connector body into which the external terminal is inserted,
a contact provided on the connector body to electrically connect the inserted external terminal thereto,
a substrate mounting formed with the connector body to electrically connect the connector body to the protective circuit board, and
a support formed on the connector body to prevent the connector body from deforming when the external terminal is inserted.

13. The battery pack as claimed in claim 12, wherein the protective circuit module comprises a substrate body having a terminal hole formed thereon to transmit the electric current from the bare cell to the substrate mounting connected to the terminal hole.

14. The battery pack as claimed in claim 12, wherein the cover frame includes a terminal slot to expose the contact of the connector to an outside of the cover frame.

15. The battery pack as claimed in claim 12, wherein the support is coupled to the connector body to support the contact.

16. The battery pack as claimed in claim 12, wherein the connector body includes first and second bending portions, each having a U-shaped section to face each other.

17. The battery pack as claimed in claim 16, wherein the connector further comprises another contact to electrically connect the inserted external terminal, wherein the contact is provided on an end of the first bending portion and the other contact is provided on an end of the second bending portion.

18. The battery pack as claimed in claim 17, wherein the connector further comprises another support formed on the connector body to prevent the connector body from deforming when the external terminal is inserted.

19. The battery pack as claimed in claim 18, wherein the support is formed on the connector body to a side of the first bending portion opposite from the contact, and the other support is formed on the connector body to a side of the second bending portion opposite from the other contact.

20. The battery pack as claimed in claim 18, wherein the external terminal is inserted between the contact and the other contact.
